(19) United States
(12) Patent Application Publication
(10) Pub. No.: US 2025/0200992 A1
(43) Pub. Date: Jun. 19, 2025

(54) INTERSECTING ROAD DETECTION DEVICE, INTERSECTING ROAD DETECTION METHOD, AND NON-TRANSITORY RECORDING MEDIUM

(71) Applicant: TOYOTA JIDOSHA KABUSHIKI KAISHA, Toyota-shi Aichi-ken (JP)

(72) Inventor: Masamichi OHSUGI, Sunto-gun Shizuoka-ken (JP)

(73) Assignee: TOYOTA JIDOSHA KABUSHIKI KAISHA, Toyota-shi Aichi-ken (JP)

(21) Appl. No.: 18/983,888

(22) Filed: Dec. 17, 2024

(30) Foreign Application Priority Data
Dec. 19, 2023 (JP) 2023-213738

(51) Int. Cl. G06V 20/56; G06V 10/75; G06V 20/10

(52) U.S. Cl. CPC G06V 20/588; G06V 10/751; G06V 20/182

(57) ABSTRACT

A intersecting road detection device acquires information indicating road pixels corresponding to roads and wall pixels corresponding to walls included in a host vehicle front image, identify wall bottom portion pixels which are portions adjacent to pixels corresponding to host vehicle travelling road included in the road pixels, identify wall high portion pixels which are portions higher than height of the host vehicle travelling road by a predetermined value or more, identify wall high edge portion pixels which are portions adjacent to pixels other than the wall pixels, and determine that an intersecting road which is a road intersecting the host vehicle travelling road exists in a position of the pixels other than the wall pixels which are adjacent to the wall high edge portion pixels when the pixels other than the wall pixels are the road pixels.

### CROSS-REFERENCE TO RELATED APPLICATIONS

This application claims priority to Japanese Patent Application No. 2023-213738 filed Dec. 19, 2023, the entire contents of which are herein incorporated by reference.

### FIELD

The present disclosure relates to intersecting road detection device, intersecting road detection method, and non-transitory recording medium.

### BACKGROUND

PTL 1 (JPH113500A) discloses that it is determined whether a shot image includes a lateral road (lateral road extending in the lateral direction with respect to a vehicle, including an oblique direction).

In the technique described in PTL 1, the measurement result of an autofocus device is used in order to determine whether the lateral road is included in the shot image. Therefore, in the technique described in PTL 1, when the information indicating the measurement result of the autofocus device is not included in the data of the shot image, it is impossible to detect the lateral road included in the shot image.

While a host vehicle is travelling, detection of an intersecting road (intersection) is required in order to respond to jumping out of bicycles, pedestrians, etc. in the vicinity of the intersection, or to reduce collision between the host vehicle and a surrounding vehicle travelling on the intersecting road which intersects a road on which the host vehicle is travelling at the intersection. When GPS (Global Positioning System) and map information are used to detect the intersection road (intersection), there is a risk that the cost may become high or the position of the intersection road (intersection) may be detected incorrectly due to misalignment of the GPS. If the intersecting road (intersection) is detected by using a partition line or the like of the road on which the host vehicle is traveling, which is included in the image obtained by shooting the front of the host vehicle, there is a possibility that the intersecting road (intersection) may not be properly detected when a clear partition line is not provided on the road on which the host vehicle is traveling. The intersecting road needs to be properly detected because the intersecting road is an area where something may run into the road on which the host vehicle is travelling.

### SUMMARY

In view of the above-described points, it is an object of the present disclosure to provide intersecting road detection device, intersecting road detection method, and non-transitory recording medium that can appropriately detect an intersecting road which intersects a road on which a host vehicle is travelling.
(1) One aspect of the present disclosure is an intersecting road detection device including a processor configured to: acquire information indicating road pixels which are pixels corresponding to roads included in an image obtained by shooting the front of a host vehicle and wall pixels which are pixels corresponding to walls included in the image, the road pixels and the wall pixels being generated from the image; identify wall bottom portion pixels which are portions adjacent to pixels corresponding to host vehicle travelling road which is a road on which the host vehicle is travelling based on the road pixels and the wall pixels, the pixels corresponding to the host vehicle travelling road being included in the road pixels, the wall bottom portion pixels being included in the wall pixels; identify wall high portion pixels which are portions higher than height of the host vehicle travelling road by a predetermined value or more based on the road pixels and the wall pixels, the wall high portion pixels being included in the wall pixels; identify wall high edge portion pixels which are portions adjacent to pixels other than the wall pixels based on the road pixels and the wall pixels, the wall high edge portion pixels being included in the wall high portion pixels; and determine that an intersecting road which is a road intersecting the host vehicle travelling road exists in a position of the pixels other than the wall pixels which are adjacent to the wall high edge portion pixels when the pixels other than the wall pixels are the road pixels.
(2) In the intersecting road detection device of the aspect (1), the processor may be configured to determine that the intersecting road does not exist in the position of the pixels other than the wall pixels which are adjacent to the wall high edge portion pixels when the pixels other than the wall pixels are not the road pixels.
(3) Another aspect of the present disclosure is an intersecting road detection method including: acquiring information indicating road pixels which are pixels corresponding to roads included in an image obtained by shooting the front of a host vehicle and wall pixels which are pixels corresponding to walls included in the image, the road pixels and the wall pixels being generated from the image; identifying wall bottom portion pixels which are portions adjacent to pixels corresponding to host vehicle travelling road which is a road on which the host vehicle is travelling based on the road pixels and the wall pixels, the pixels corresponding to the host vehicle travelling road being included in the road pixels, the wall bottom portion pixels being included in the wall pixels; identifying wall high portion pixels which are portions higher than height of the host vehicle travelling road by a predetermined value or more based on the road pixels and the wall pixels, the wall high portion pixels being included in the wall pixels; identifying wall high edge portion pixels which are portions adjacent to pixels other than the wall pixels based on the road pixels and the wall pixels, the wall high edge portion pixels being included in the wall high portion pixels; and determining that an intersecting road which is a road intersecting the host vehicle travelling road exists in a position of the pixels other than the wall pixels which are adjacent to the wall high edge portion pixels when the pixels other than the wall pixels are the road pixels.
(4) Another aspect of the present disclosure is a non-transitory recording medium having recorded thereon a computer program for causing a processor to perform a process including: acquiring information indicating road pixels which are pixels corresponding to roads included in an image obtained by shooting the front of a host vehicle and wall pixels which are pixels corresponding to walls included in the image, the road pixels and the wall pixels being generated from the image; identifying wall bottom portion pixels which are portions adjacent to pixels corresponding to host vehicle travelling road which is a road on which the host vehicle is travelling based on the road pixels and the wall pixels, the pixels corresponding to the host vehicle travelling road being included in the road pixels, the wall bottom portion pixels being included in the wall pixels; identifying wall high portion pixels which are portions higher than height of the host vehicle travelling road by a predetermined value or more based on the road pixels and the wall pixels, the wall high portion pixels being included in the wall pixels; identifying wall high edge portion pixels which are portions adjacent to pixels other than the wall pixels based on the road pixels and the wall pixels, the wall high edge portion pixels being included in the wall high portion pixels; and determining that an intersecting road which is a road intersecting the host vehicle travelling road exists in a position of the pixels other than the wall pixels which are adjacent to the wall high edge portion pixels when the pixels other than the wall pixels are the road pixels.

According to the present disclosure, it is possible to appropriately detect the intersecting road which intersects the road on which the host vehicle is travelling.

### BRIEF DESCRIPTION OF DRAWINGS

FIG. 1 is a view showing an example of a host vehicle 1 to which an intersecting road detection device 15 of a first embodiment is applied.

FIG. 2 is a view showing a first example of process result of image segmentation performed by an image process device 3A and the like.

FIG. 3 is a view showing a second example of the process result of the image segmentation performed by the image process device 3A and the like.

FIG. 4 is a flowchart for explaining an example of a process performed by a processor 153 of the intersecting road detection device 15 of the first embodiment.

FIG. 5 is a view showing an example of the host vehicle 1 to which the intersecting road detection device 15 of a second embodiment is applied.

### DESCRIPTION OF EMBODIMENTS

Below, referring to the drawings, embodiments of intersecting road detection device, intersecting road detection method, and non-transitory recording medium of the present disclosure will be explained.

### First Embodiment

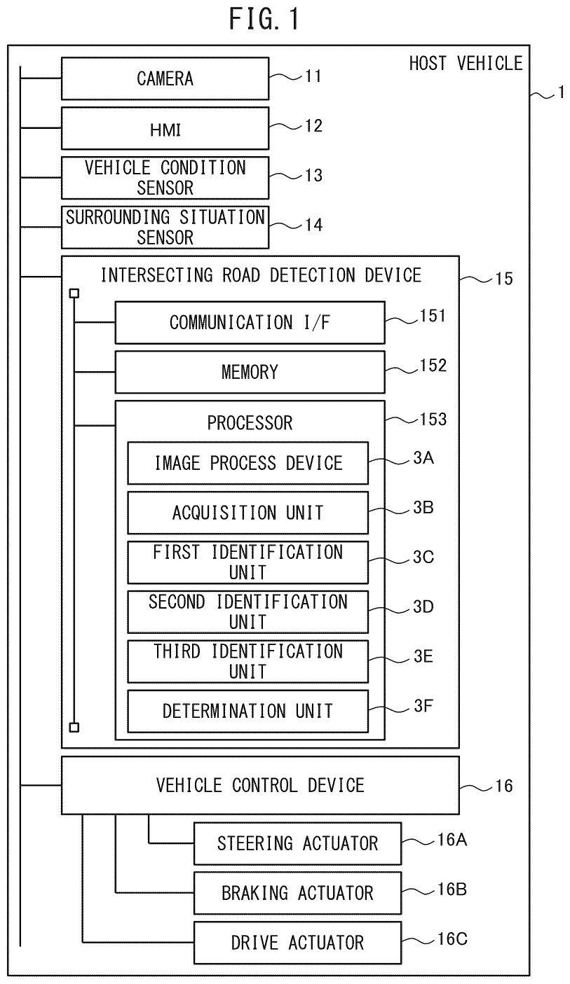

FIG. 1 is a view showing an example of a host vehicle 1 to which an intersecting road detection device 15 of a first embodiment is applied.

In the example shown in FIG. 1, the host vehicle 1 includes camera 11, HMI (Human Machine Interface) 12, vehicle condition sensor 13, surrounding situation sensor 14, intersecting road detection device 15, vehicle control device 16, steering actuator 16A, braking actuator 16B, and drive actuator 16C.

The camera 11 shoots the front of the host vehicle 1 and transmits data of a host vehicle front image to the intersecting road detection device 15 and the vehicle control device 16.

The HMI 12 has the function of receiving various operations of a driver of the host vehicle 1 and the like and transmits signals indicating the operations of the driver of the host vehicle 1 to the vehicle control device 16.

The vehicle condition sensor 13 detects condition of the host vehicle 1 and transmits the detection result to the vehicle control device 16. The vehicle condition sensor 13 includes, for example, vehicle speed sensor and the like.

The surrounding situation sensor 14 detects, for example, obstacle, surrounding vehicle, pedestrian and the like existing in the vicinity of the host vehicle 1 and transmits the detection result to the vehicle control device 16. The surrounding situation sensor 14 includes, for example, camera for shooting the side, the rear, and the like of the host vehicle 1, LiDAR (Light Detection And Ranging), radar, sonar or the like.

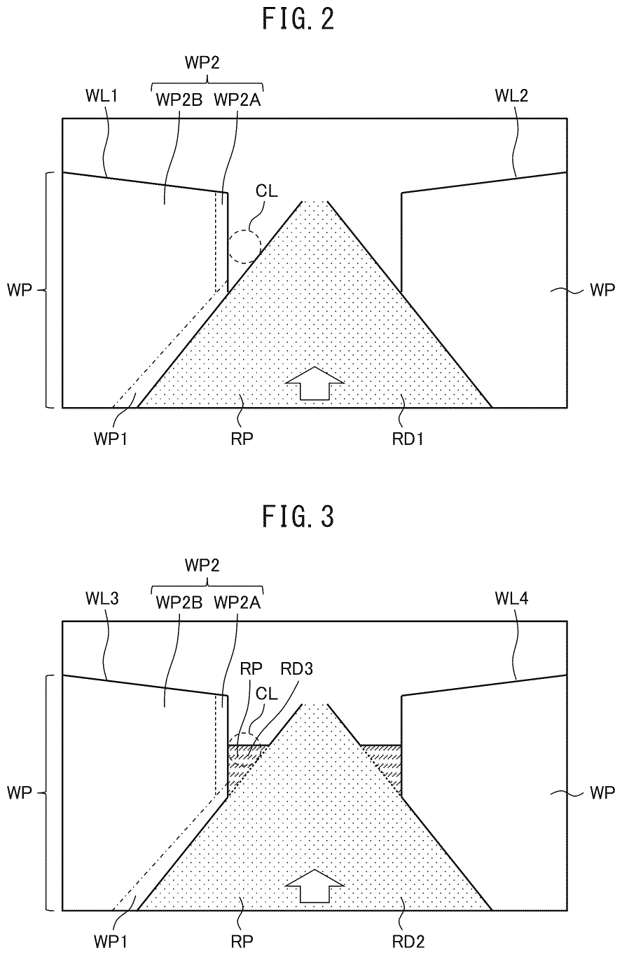

The intersecting road detection device 15 detects a road (intersecting road RD3 (refer to FIG. 3)) which intersect a road on which the host vehicle 1 is travelling (host vehicle travelling road RD1, RD2 (see FIG. 2 and FIG. 3)) and transmits the detection result to the vehicle control device 16.

The vehicle control device 16 is configured by a driving assistance ECU (Electronic Control Unit). The vehicle control device 16 controls the steering actuator 16A, the braking actuator 16B, and the drive actuator 16C based on, for example, information (data, signals) transmitted from the camera 11, the HMI 12, the vehicle condition sensor 13, the surrounding situation sensor 14 and the intersecting road detection device 15.

The intersecting road detection device 15 is configured by a microcomputer which includes communication interface (I/F) 151, memory 152 and processor 153. The communication interface 151 includes an interface circuit for connecting the intersecting road detection device 15 to the camera 11 and the vehicle control device 16. The memory 152 stores program used in a process performed by the processor 153 and various data. The processor 153 has the function as an image process device 3A, the function as an acquisition unit 3B, the function as a first identification unit 3C, the function as a second identification unit 3D, the function as a third identification unit 3E and the function as a determination unit 3F.

The image process device 3A acquires the data of the host vehicle front image transmitted from the camera 11. In addition, the image process device 3A executes a process of image segmentation (identification of a subject included in the image) such as, for example, semantic segmentation or the like for the host vehicle front image.

FIG. 2 and FIG. 3 are views showing examples of process result of the image segmentation performed by the image process device 3A. Specifically, FIG. 2 shows a first example of the process result of the image segmentation performed by the image process device 3A and the like. FIG. 3 shows a second example of the process result of the image segmentation performed by the image process device 3A and the like.

In the example shown in FIG. 2, the process result of the image segmentation executed by the image process device 3A for the host vehicle front image shot by the camera 11 includes road pixels RP corresponding to a road on which the host vehicle 1 is travelling (host vehicle travelling road RD1) and wall pixels WP corresponding to walls WL1, WL2 provided adjacently to the host vehicle travelling road RD1. The wall pixels WP corresponding to the wall WL1 includes wall bottom portion pixels WP1 which are portions adjacent to the road pixels RP corresponding to the host vehicle travelling road RD1 and wall high portion pixels WP2 which are portions higher than the height of the host vehicle travelling road RD1 by a predetermined value (for example, several tens of centimeters or the like) or more. The wall high portion pixels WP2 includes wall high edge portion pixels WP2A which are portions adjacent to pixels other than the wall pixels WP (e.g., pixels corresponding to a portion surrounded by a circular CL in FIG. 2) and wall high non-edge portion pixels WP2B which are portions which are not adjacent to the pixels other than the wall pixels WP.

In the example shown in FIG. 3, the process result of the image segmentation executed by the image process device 3A for the host vehicle front image shot by the camera 11 includes the road pixels RP corresponding to a road on which the host vehicle 1 is travelling (host vehicle travelling road RD2) and a road (intersecting road RD3) intersecting the host vehicle travelling road RD2, and the wall pixels WP corresponding to walls WL3, WL4 provided adjacently to the host vehicle travelling road RD2. The wall pixels WP corresponding to the wall WL3 includes the wall bottom portion pixels WP1, the wall high edge portion pixels WP2A and the wall high non-edge portion pixels WP2B of the wall high portion pixels WP2.

In the example shown in FIG. 1, the acquisition unit 3B acquires information indicating the road pixels RP, the wall pixels WP and the like from the process result of the image segmentation executed by the image process device 3A.

That is, the acquisition unit 3B acquires the information indicating pixels corresponding to the roads RD1, RD2, RD3 (road pixels RP) included in the host vehicle front image and pixels corresponding to the walls WL1, WL2, WL3, WL4 (wall pixels WP) included in the host vehicle front image and the like, which is generated from the image (the host vehicle front image) obtained by shooting the front of the host vehicle 1.

Specifically, in the example shown in FIG. 2, the acquisition unit 3B acquires the information indicating the road pixels RP corresponding to the host vehicle travelling road RD1, the wall pixels WP corresponding to the walls WL1, WL2 and the like.

In the example shown in FIG. 3, the acquisition unit 3B acquires the information indicating the road pixels RP corresponding to the host vehicle travelling road RD2 and the intersecting road RD3, the wall pixels WP corresponding to the walls WL3, WL4, and the like.

In the example shown in FIG. 1, the first identification unit 3C identifies the wall bottom portion pixels WP1 which are portions adjacent to pixels corresponding to host vehicle travelling roads RD1, RD2 included in the road pixels RP based on the road pixels RP and the wall pixels WP indicated by the information acquired by the acquisition unit 3B, the wall bottom portion pixels WP1 are included in the wall pixels WP.

In more detail, in the example shown in FIG. 2, the first identification unit 3C identifies the wall bottom portion pixels WP1 which are portions adjacent to the pixels corresponding to the host vehicle travelling road RD1 included in the road pixels RP based on the road pixels RP and the wall pixels WP indicated by the information acquired by the acquisition unit 3B, the wall bottom portion pixels WP1 are included in the wall pixels WP.

In the example shown in FIG. 3, the first identification unit 3C identifies the wall bottom portion pixels WP1 which are portions adjacent to the pixels corresponding to the host vehicle travelling road RD2 included in the road pixels RP based on the road pixels RP and the wall pixels WP indicated by the information acquired by the acquisition unit 3B, the wall bottom portion pixels WP1 are included in the wall pixels WP.

In the example shown in FIG. 1, the second identification unit 3D identifies the wall high portion pixels WP2 which are portions higher than the height of the host vehicle travelling roads RD1, RD2 by the predetermined value or more based on the road pixels RP and the wall pixels WP indicated by the information acquired by the acquisition unit 3B, the wall high portion pixels WP2 are included in the wall pixels WP.

In more detail, in the example shown in FIG. 2, the second identification unit 3D identifies the wall high portion pixels WP2 which are portions higher than the height of the host vehicle travelling road RD1 by the predetermined value or more based on the road pixels RP and the wall pixels WP indicated by the information acquired by the acquisition unit 3B, the wall high portion pixels WP2 are included in the wall pixels WP.

In the example shown in FIG. 3, the second identification unit 3D identifies the wall high portion pixels WP2 which are portions higher than the height of the host vehicle travelling road RD2 by the predetermined value or more based on the road pixels RP and the wall pixels WP indicated by the information acquired by the acquisition unit 3B, the wall high portion pixels WP2 are included in the wall pixels WP.

In the example shown in FIG. 1, the third identification unit 3E identifies the wall high edge portion pixels WP2A which are portions adjacent to the pixels other than the wall pixels WP based on the road pixels RP and the wall pixels WP indicated by the information acquired by the acquisition unit 3B, the wall high edge portion pixels WP2A are included in the wall high portion pixels WP2.

In more detail, in the example shown in FIG. 2, the third identification unit 3E identifies the wall high edge portion pixels WP2A which are portions adjacent to the pixels other than the wall pixels WP (e.g., the pixels corresponding to the portion surrounded by the circular CL in FIG. 2, etc.) based on the road pixels RP and the wall pixels WP indicated by the information acquired by the acquisition unit 3B, the wall high edge portion pixels WP2A are included in the wall high portion pixels WP2. In the example shown in FIG. 2, for example, pixels corresponding to a fence, pixels corresponding to boundary planting, pixels corresponding to a guard rail, pixels corresponding to a field, pixels corresponding to a river and the like correspond to the “the pixels other than the wall pixels WP.”

In the example shown in FIG. 3, the third identification unit 3E identifies the wall high edge portion pixels WP2A which are portions adjacent to the pixels other than the wall pixels WP (e.g., the pixels corresponding to the portion surrounded by the circular CL in FIG. 3, etc.) based on the road pixels RP and the wall pixels WP indicated by the information acquired by the acquisition unit 3B, the wall high edge portion pixels WP2A are included in the wall high portion pixels WP2. In the example shown in FIG. 3, for example, the road pixels RP corresponding to the intersecting road RD3 correspond to “the pixels other than the wall pixels WP.”

In the example shown in FIG. 1, the determination unit 3F determines whether the pixels other than the wall pixels WP adjacent to the wall high edge portion pixels WP2A are the road pixels RP. When the pixels other than the wall pixels WP adjacent to the wall high edge portion pixels WP2A are the road pixels RP, the determination unit 3F determines that the intersecting road RD3 which is the road intersecting the host vehicle travelling road RD2 exists in a position of the pixels other than the wall pixels WP which are adjacent to the wall high edge portion pixels WP2A. On the other hand, when the pixels other than the wall pixels WP adjacent to the wall high edge portion pixels WP2A are not the road pixels RP, the determination unit 3F determines that the intersecting road (the road intersecting the host vehicle travelling road RD1) does not exist in the position of the pixels other than the wall pixels WP which are adjacent to the wall high edge portion pixels WP2A.

Specifically, in the example shown in FIG. 2, since the pixels other than the wall pixels WP adjacent to the wall high edge portion pixels WP2A (e.g., the pixels corresponding to the portion surrounded by the circular CL in FIG. 2 or the like) are not the road pixels RP, the determination unit 3F determines that the intersecting road (the road intersecting the host vehicle travelling road RD1) does not exist in the position of the pixels other than the wall pixels WP adjacent to the wall high edge portion pixels WP2A.

In the example shown in FIG. 3, since the pixels other than the wall pixel WP adjacent to the wall high edge portion pixels WP2A (e.g., the pixels corresponding to the portion surrounded by the circular CL in FIG. 3 or the like) are the road pixels RP, the determination unit 3F determines that the intersecting road RD3 exists in the position of the pixels other than the wall pixels WP adjacent to the wall high edge portion pixels WP2A.

In the example shown in FIG. 1, when the determination unit 3F determines that the intersecting road RD3 exists in the position of the pixels other than the wall pixels adjacent to the wall high edge portion pixels WP2A, the vehicle control device 16 (driving assistance ECU) makes the HMI 12 output an alarm indicating that the intersecting road RD3 exists in the position of the pixels other than the wall pixels adjacent to the wall high edge portion pixels WP2A (that is, in front of the traveling direction of the host vehicle 1), for example, by displaying, audio or the like, based on the detection result of the intersecting road detection device 15 (determination result of the determination unit 3F).

In another example, when the determination unit 3F determines that the intersecting road RD3 exists in the position of the pixels other than the wall pixels adjacent to the wall high edge portion pixels WP2A, the vehicle control unit 16 (driving assistance ECU) may perform braking assistance and/or steering assistance for avoiding collisions between another vehicle, a pedestrian, or the like jumping out from the intersecting road RD3 to the host vehicle travelling road RD2 and the host vehicle 1.

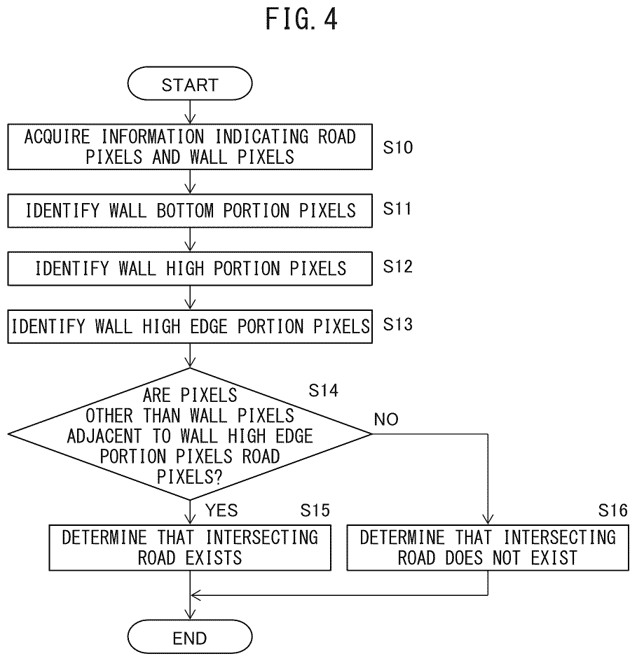

FIG. 4 is a flowchart for explaining an example of the process performed by the processor 153 of the intersecting road detection device 15 of the first embodiment.

In the example shown in FIG. 4, at step S10, the acquisition unit 3B acquires the information indicating the road pixels RP and the wall pixels WP.

At step S11, the first identification unit 3C identifies the wall bottom portion pixels WP1 which are portions adjacent to the pixels corresponding to the host vehicle travelling roads RD1, RD2 included in the road pixels RP based on the road pixels RP and the wall pixels WP indicated by the information acquired at step S10, the wall bottom portion pixels WP1 are included in the wall pixels WP.

At step S12, the second identification unit 3D identifies the wall high portion pixels WP2 which are portions higher than the height of the host vehicle travelling roads RD1, RD2 by the predetermined value or more based on the road pixels RP and the wall pixels WP indicated by the information acquired at step S10, the wall high portion pixels WP2 are included in the wall pixels WP.

At step S13, the third identification unit 3E identifies the wall high edge portion pixels WP2A which are portions adjacent to the pixels other than the wall pixels WP based on the road pixels RP and the wall pixels WP indicated by the information acquired at step S10, the wall high edge portion pixels WP2A are included in the wall high portion pixels WP2 identified at step S12.

At step S14, the determination unit 3F determines whether the pixels other than the wall pixels WP adjacent to the wall high edge portion pixels WP2A identified at step S12 are the road pixels RP. When YES, it proceeds to step S15; when NO, it proceeds to step S16.

At step S15, the determination unit 3F determines that the intersecting road RD3 which is the road intersecting the host vehicle travelling road RD2 exists in the position of the pixels other than the wall pixels WP adjacent to the wall high edge portion pixels WP2A identified at step S12.

At step S16, the determination unit 3F determines that the intersecting road (the road intersecting the host vehicle travelling road RD1) does not exist in the position of the pixels other than the wall pixels WP adjacent to the wall high edge portion pixels WP2A identified at step S12.

In the intersecting road detection device 15 of the first embodiment, it is used that a situation in which the wall high edge portion pixels WP2A which should not normally be adjacent to the road pixels RP are adjacent to the road pixels RP corresponding to the intersecting road RD3 when the road pixels RP corresponding to the intersecting road RD3 are included in the process result of the image segmentation (the process result of the image segmentation shown in FIG. 3, for example) occurs in the process result of the image segmentation performed on the host vehicle front image shot by the camera 11 in a scene in which a part of the intersecting road RD3 intersecting the host vehicle travelling road RD2 is hidden by the wall WL3.

Furthermore, in the intersecting road detection device 15 of the first embodiment, as described above, when the pixels other than the wall pixel WP adjacent to the wall high edge portion pixels WP2A are the road pixels RP, it is determined that the intersecting road RD3 intersecting the host vehicle travelling road RD2 exists in the position of the pixels other than the wall pixels WP adjacent to the wall high edge portion pixels WP2A.

In the intersecting road detection device 15 of the first embodiment, in order to detect the road pixels RP, the wall pixels WP, and the like included in the host vehicle front image (in other words, to detect the attribute of the pixels), for example, the “label for each pixel” calculated (output) in the process of the semantic segmentation (process in the image process device 3A) in which an attribute is assigned to each of the plurality of pixels included in the image is utilized.

### Second Embodiment

The host vehicle 1 to which the intersecting road detection device 15 of a second embodiment is applied is configured similarly to the host vehicle 1 to which the intersecting road detection device 15 of the first embodiment described above is applied, except that it will be described later.

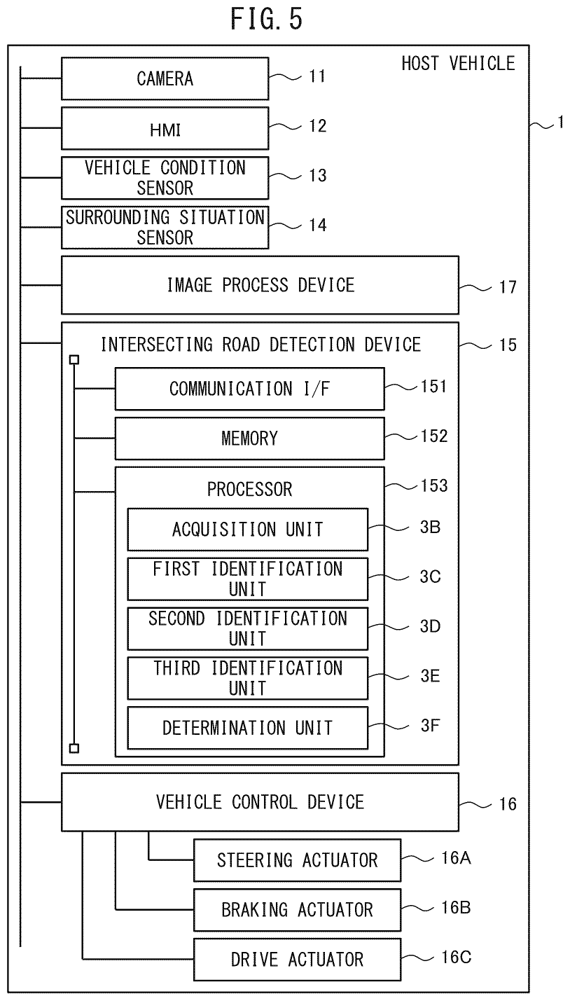

FIG. 5 is a view showing an example of the host vehicle 1 to which the intersecting road detection device 15 of the second embodiment is applied.

In the example of the host vehicle 1 to which the intersecting road detection device 15 of the first embodiment is applied as described above (the example shown in FIG. 1), the processor 153 of the intersecting road detection device 15 has the function as the image process device 3A.

On the other hand, in the example shown in FIG. 5, the processor 153 of the intersecting road detection device 15 does not have the function as the image process device 3A, and the image process device 17 having the same function as the image process device 3A is provided outside the intersecting road detection device 15. That is, in the example shown in FIG. 5, the host vehicle 1 is provided with the image process device 17 separately from the intersecting road detection device 15.

In the example shown in FIG. 5, the camera 11 transmits the data of the host vehicle front image to the vehicle control device 16 and the image process device 17. The image process device 17 acquires the data of the host vehicle front image transmitted from the camera 11. In addition, the image process device 17 executes the process of the image segmentation (identification of the subject included in the image) such as, for example, the semantic segmentation or the like for the host vehicle front image. The acquisition unit 3B acquires the information indicating the road pixels RP, the wall pixels WP and the like from the process result of the image segmentation executed by the image process device 17.

### Third Embodiment

The host vehicle 1 to which the intersecting road detection device 15 of a third embodiment is applied is configured similarly to the host vehicle 1 to which the intersecting road detection device 15 of the first embodiment described above is applied, except that it will be described later.

In the example of the host vehicle 1 to which the intersecting road detection device 15 of the first embodiment is applied as described above (the example shown in FIG. 1), the vehicle control device 16 is configured by the driving assistance ECU.

On the other hand, in the example of the host vehicle 1 to which the intersecting road detection device 15 of the third embodiment is applied, the vehicle control device 16 is configured by an autonomous driving ECU.

In the example of the host vehicle 1 to which the intersecting road detection device 15 of the first embodiment is applied as described above (the example shown in FIG. 1), when the determination unit 3F determines that the intersecting road RD3 exists in the position of the pixels other than the wall pixels WP adjacent to the wall high edge portion pixels WP2A, the vehicle control device 16 (driving assistance ECU) makes the HMI 12 output the alarm indicating that the intersecting road RD3 exists in the position of the pixels other than the wall pixels adjacent to the wall high edge portion pixels WP2A (that is, in front of the traveling direction of the host vehicle 1), for example, by displaying, audio or the like, based on the detection result of the intersecting road detection device 15 (determination result of the determination unit 3F).

On the other hand, in the example of the host vehicle 1 to which the intersecting road detection device 15 of the third embodiment is applied, when the determination unit 3F determines that the intersecting road RD3 exists in the position of the pixels other than the wall pixels WP adjacent to the wall high edge portion pixels WP2A, the vehicle control device 16 (autonomous driving ECU) generates a traveling plan of the host vehicle 1 for avoiding the collisions between another vehicle, a pedestrian, or the like jumping out from the intersecting road RD3 to the host vehicle travelling road RD2 and the host vehicle 1, and controls the steering actuator 16A, the braking actuator 16B, and the drive actuator 16C based on the traveling plan.

### Fourth Embodiment

The host vehicle 1 to which the intersecting road detection device 15 of a fourth embodiment is applied is configured similarly to the host vehicle 1 to which the intersecting road detection device 15 of the second embodiment described above is applied, except that it will be described later.

In the example of the host vehicle 1 to which the intersecting road detection device 15 of the second embodiment is applied as described above (the example shown in FIG. 5), the vehicle control device 16 is configured by the driving assistance ECU.

On the other hand, in an example of the host vehicle 1 to which the intersecting road detection device 15 of the fourth embodiment is applied, the vehicle control device 16 is configured by the autonomous driving ECU. In the example of the host vehicle 1 to which the intersecting road detection device 15 of the fourth embodiment is applied, similar to the example of the host vehicle 1 to which the intersecting road detection device 15 of the third embodiment described above is applied, when the determination unit 3F determines that the intersecting road RD3 exists in the position of the pixels other than the wall pixels WP adjacent to the wall high edge portion pixels WP2A, the vehicle control device 16 (autonomous driving ECU) generates the traveling plan of the host vehicle 1 for avoiding the collisions between another vehicle, a pedestrian, or the like jumping out from the intersecting road RD3 to the host vehicle travelling road RD2 and the host vehicle 1, and controls the steering actuator 16A, the braking actuator 16B, and the drive actuator 16C based on the traveling plan.

As described above, although the embodiments of the intersecting road detection device, the intersecting road detection method, and the non-transitory recording medium of the present disclosure have been described with reference to the drawings, the intersecting road detection device, the intersecting road detection method, and the non-transitory recording medium of the present disclosure are not limited to the above-described embodiments, and may be appropriately changed without departing from the scope of the present disclosure. The configuration of each example of the embodiment described above may be appropriately combined. In each example of the above-described embodiment, the process performed in the intersecting road detection device 15 has been described as a software process performed by executing a program, but the process performed in the intersecting road detection device 15 may be a process performed by hardware. Alternatively, the process performed by the intersecting road detection device 15 may be a combined process of both software and hardware. Further, the program (the program for realizing the function of the processor 153 of the intersecting road detection device 15) that is stored in the memory 152 of the intersecting road detection device 15 may be recorded in a computer-readable storage medium (a non-transitory recording medium) such as, for example, a semiconductor memory, a magnetic recording medium, an optical recording medium, or the like for providing, distribution or the like.

1. An intersecting road detection device comprising a processor configured to:
acquire information indicating road pixels which are pixels corresponding to roads included in an image obtained by shooting the front of a host vehicle and wall pixels which are pixels corresponding to walls included in the image, the road pixels and the wall pixels being generated from the image;
identify wall bottom portion pixels which are portions adjacent to pixels corresponding to host vehicle travelling road which is a road on which the host vehicle is travelling based on the road pixels and the wall pixels, the pixels corresponding to the host vehicle travelling road being included in the road pixels, the wall bottom portion pixels being included in the wall pixels;
identify wall high portion pixels which are portions higher than height of the host vehicle travelling road by a predetermined value or more based on the road pixels and the wall pixels, the wall high portion pixels being included in the wall pixels;
identify wall high edge portion pixels which are portions adjacent to pixels other than the wall pixels based on the road pixels and the wall pixels, the wall high edge portion pixels being included in the wall high portion pixels; and
determine that an intersecting road which is a road intersecting the host vehicle travelling road exists in a position of the pixels other than the wall pixels which are adjacent to the wall high edge portion pixels when the pixels other than the wall pixels are the road pixels.

2. The intersecting road detection device according to claim 1, wherein the processor is configured to
determine that the intersecting road does not exist in the position of the pixels other than the wall pixels which are adjacent to the wall high edge portion pixels when the pixels other than the wall pixels are not the road pixels.

3. An intersecting road detection method comprising:
acquiring information indicating road pixels which are pixels corresponding to roads included in an image obtained by shooting the front of a host vehicle and wall pixels which are pixels corresponding to walls included in the image, the road pixels and the wall pixels being generated from the image;
identifying wall bottom portion pixels which are portions adjacent to pixels corresponding to host vehicle travelling road which is a road on which the host vehicle is travelling based on the road pixels and the wall pixels, the pixels corresponding to the host vehicle travelling road being included in the road pixels, the wall bottom portion pixels being included in the wall pixels;
identifying wall high portion pixels which are portions higher than height of the host vehicle travelling road by a predetermined value or more based on the road pixels and the wall pixels, the wall high portion pixels being included in the wall pixels;
identifying wall high edge portion pixels which are portions adjacent to pixels other than the wall pixels based on the road pixels and the wall pixels, the wall high edge portion pixels being included in the wall high portion pixels; and
determining that an intersecting road which is a road intersecting the host vehicle travelling road exists in a position of the pixels other than the wall pixels which are adjacent to the wall high edge portion pixels when the pixels other than the wall pixels are the road pixels.

4. A non-transitory recording medium having recorded thereon a computer program for causing a processor to perform a process comprising:
acquiring information indicating road pixels which are pixels corresponding to roads included in an image obtained by shooting the front of a host vehicle and wall pixels which are pixels corresponding to walls included in the image, the road pixels and the wall pixels being generated from the image;
identifying wall bottom portion pixels which are portions adjacent to pixels corresponding to host vehicle travelling road which is a road on which the host vehicle is travelling based on the road pixels and the wall pixels, the pixels corresponding to the host vehicle travelling road being included in the road pixels, the wall bottom portion pixels being included in the wall pixels;
identifying wall high portion pixels which are portions higher than height of the host vehicle travelling road by a predetermined value or more based on the road pixels and the wall pixels, the wall high portion pixels being included in the wall pixels;
identifying wall high edge portion pixels which are portions adjacent to pixels other than the wall pixels based on the road pixels and the wall pixels, the wall high edge portion pixels being included in the wall high portion pixels; and
determining that an intersecting road which is a road intersecting the host vehicle travelling road exists in a position of the pixels other than the wall pixels which are adjacent to the wall high edge portion pixels when the pixels other than the wall pixels are the road pixels.
